(19) United States
(12) Patent Application Publication
(10) Pub. No.: US 2013/0222728 A1
(43) Pub. Date: Aug. 29, 2013

(54) LCD Device

(71) Applicants: Shihhsiang Chen, Shenzhen (CN); Jiahe Cheng, Shenzhen (CN)

(72) Inventors: Shihhsiang Chen, Shenzhen (CN); Jiahe Cheng, Shenzhen (CN)

(21) Appl. No.: 13/503,982

(22) PCT Filed: Mar. 1, 2012
(86) PCT No.: PCT/CN2012/071810

§ 371 Date: Apr. 25, 2012

(30) Foreign Application Priority Data
Feb. 29, 2012 (CN) 2012100492454

(51) Int. Cl. G02F 1/1333

(52) U.S. Cl. 349/58

(57) ABSTRACT

The invention relates to the field of LCDs, and more particularly to an LCD device, including: a backplane, and wall mounting holes; the wall mounting holes are distributed in the four corners of the back of the backplane. The LCD device of the invention has the advantages that the conventional wall mounting position is changed, the wall mounting holes are arranged in the four corners of the back of the backplane and are relatively staggered to the position of the PCB, so that the backplane, especially the structure in the middle of the back of the backplane becomes simple, and the cost of the backplane is reduced, favoring to the light and thin design of LCD devices.

### TECHNICAL FIELD

The invention relates to the field of liquid crystal displays (LCDs), and more particularly to an LCD device.

### BACKGROUND

Conventional LCD products, such as an LCD TV or an LCD, as shown in FIG. 1, mainly have two mounting types including wall mounting type and base type. When the wall mounting type is employed, it is necessary to arrange screw holes, also called wall mounting holes, on the back of the LCD product; the wall mounting holes are generally arranged in the middle of the back of a display module backplane, and the number of the wall mounting holes is four in general; a printed circuit board (PCB) of the display module is generally arranged in the middle of the back of the backplane; thus, the back of the backplane is provided with multiple hillocks to arrange the PCB and the wall mounting holes, thereby causing the processing of backplanes to be complicated and the processing cost to be high, and not favoring to the light and thin design of LCD devices.

### SUMMARY

In view of the above-described problems, the aim of the invention is to provide an LCD device with advantages of light weight, small thickness, and simple structure.

The purpose of the invention is achieved by the following technical scheme.

An LCD device comprises a backplane and wall mounting holes; the wall mounting holes are distributed in the four corners of the back of the backplane.

Preferably, the backplane comprises a frame; the wall mounting holes are arranged in the four corners of the frame.

Preferably, the frame of the backplane comprises multiple frame members.

Preferably, the backplane is a frame comprising multiple frame members. The backplane is simplified into a frame structure assembled with only several frame members, thus, the structure of the backplane is further simplified, and the cost of the backplane is reduced.

Preferably, the multiple frame members form the frame of the backplane by riveting, jointing or locking screws.

Preferably, the LCD device further comprises a display module and a PCB; the display module is arranged inside the backplane, the PCB is arranged outside the backplane, and the display module is electrically connected with the PCB by a wire. The PCB and the display module use the wire to conduct electricity and transmit signals. Because the PCB is arranged outside the backplane, namely the PCB is externally arranged, the interference produced by the PCB to the transmission signal of the display module is avoided, the adverse effect caused by the heat of the elements of the PCB to the display module is prevented, the reduction of display quality is avoided, the thickness of the LCD device is reduced, the ultrathin product is designed, the backplane is further simplified, and the cost is reduced.

Preferably, the LCD device further comprises a base and a bracket; the PCB is arranged on the bracket. The PCB is arranged on the bracket between the display module and the base, and thus the space between the base and the LCD module is fully used.

Preferably, the PCB is arranged in a protective case.

Preferably, the protective case is arranged on the rear of the bracket.

Advantages of the invention are summarized below: the conventional wall mounting position is changed by the LCD device of the invention, the wall mounting holes are arranged in the four corners of the back of the backplane and are relatively staggered to the position of the PCB, so that the backplane, especially the structure in the middle of the back of the backplane, becomes simple, and the cost of the backplane is reduced, favoring to the light and thin design of LCD devices.

### BRIEF DESCRIPTION OF FIGURES

FIG. 1 of a back view of an LCD device in the prior art;

FIG. 2 is a back view of an LCD device of a first example of the invention;

FIG. 3 is a front view of an LCD device of a second example of the invention; and

FIG. 4 is a side view of an LCD device of a second example of the invention.

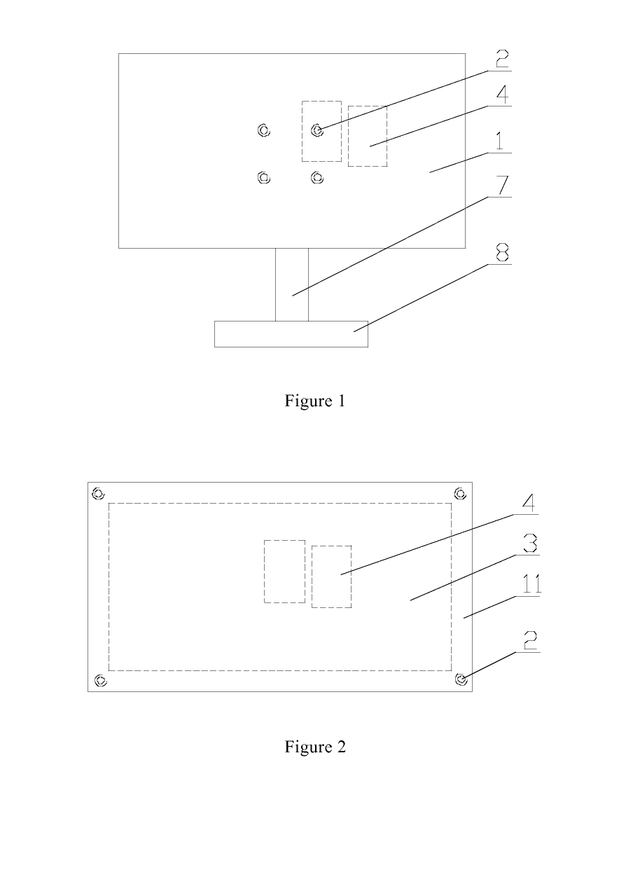

Wherein: 1. backplane; 11. frame; 2. wall mounting hole; 3. display module; 4. PCB; 5. wire; 6. base; 7. bracket; 8. protective case.

### DETAILED DESCRIPTION

The invention discloses an LCD device. A first example of the LCD device is shown in FIG. 2. The LCD device comprises a backplane 1, and wall mounting holes 2; the wall mounting holes 2 are distributed in the four corners of the back of the backplane 1.

The conventional wall mounting position is changed by the LCD device of the invention. The wall mounting holes 2 are arranged in the four corners of the back of the backplane 1 and are relatively staggered to the position of the PCB 4, so that the backplane 1, especially the structure in the middle of the back of the backplane 1, becomes simple, and the cost of the backplane 1 is reduced, favoring to the light and thin design of LCD devices.

In the example, the backplane 1 comprises a frame 11, the wall mounting holes 2 are arranged in the four corners of the frame 11; the frame 11 of the backplane 1 comprises multiple frame members, and the multiple frame members form the frame 11 of the backplane by riveting, jointing or locking screws. The frame 11 of the backplane 1 is simplified into a frame structure with only several frame members, the structure of the backplane 1 is further simplified, and the cost of the backplane 1 is reduced. The backplane 1 can be only a frame 11 comprising multiple frame members.

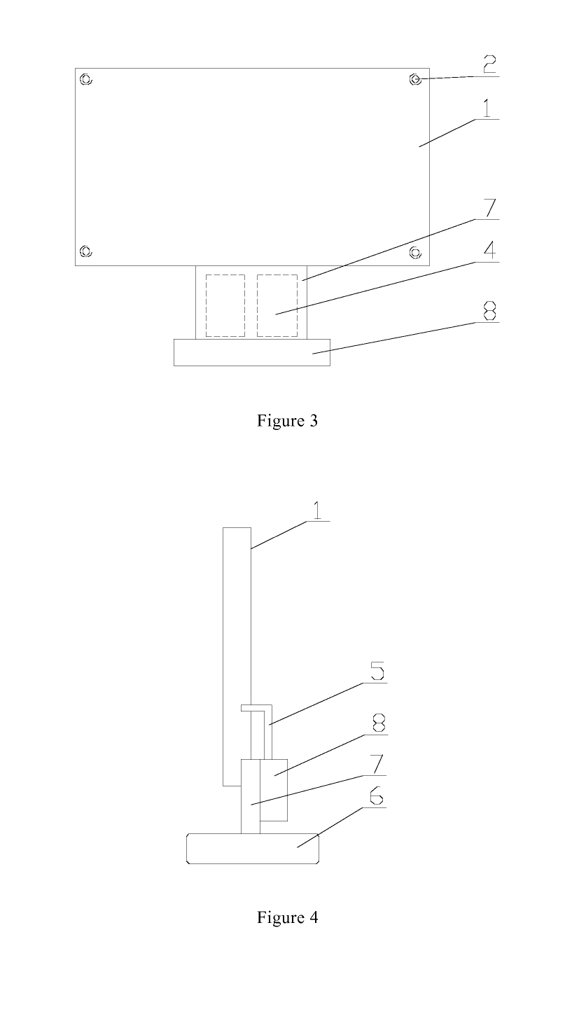

A second example of the LCD device of the invention is shown in FIG. 3 and FIG. 4, and the second example is different from the first example in that: the LCD device further comprises a display module (not shown in the figure) and a PCB 4; the display module is arranged inside the backplane 1, the PCB 4 is arranged outside the backplane 1, and the display module is electrically connected with the PCB 4 by a wire 5. The PCB 4 and the display module use the wire 5 to conduct electricity and transmit signals. Because the PCB 4 is arranged outside the backplane 1, namely the PCB 4 is externally arranged, the interference produced by the PCB 4 to the transmission signal of the display module is avoided, the adverse effect caused by the heat of the elements of the PCB 4 to the display module is prevented, the reduction of display quality is avoided, the thickness of the LCD device is reduced, the ultrathin product is designed, the backplane 1 is further simplified, and the cost is reduced.

In the example, the backplane is in an integrated structure. Optionally, the frame backplane comprising multiple frame members of the first example can be employed, and the same beneficial effect can be obtained.

In the example, the LCD device further comprises a base 6 and a bracket 7; the PCB 4 is arranged in a protective case 8, and the PCB 4 and the protective case 8 are specifically arranged on the rear of the bracket 7. The PCB 4 is arranged on the bracket 7 between the display module and the base 6, and thus the space between the base 6 and the LCD module is fully used. In the example, the PCB 4 can be arranged inside the bracket 7, and even can be arranged inside the base 6.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. An LCD device, comprising: a backplane, and wall mounting holes; wherein said wall mounting holes are distributed in the four corners of the back of said backplane.

2. The LCD device of claim 1, wherein said backplane comprises a frame; said wall mounting holes are arranged in the four corners of said frame.

3. The LCD device of claim 2, wherein the frame of said backplane comprises multiple frame members.

4. The LCD device of claim 2, wherein said backplane is a frame comprising multiple frame members.

5. The LCD device of claim 3, wherein said multiple frame members form the frame of said backplane by riveting, jointing or locking screws.

6. The LCD device of claim 4, wherein said multiple frame members form the frame of said backplane by riveting, jointing or locking screws.

7. The LCD device of claim 1, wherein said LCD device further comprises a display module and a PCB; said display module is arranged inside the backplane, said PCB is arranged outside the backplane, and said display module is electrically connected with said PCB by a wire.

8. The LCD device of claim 2, wherein said LCD device further comprises a display module and a PCB; said display module is arranged inside the backplane, said PCB is arranged outside the backplane, and said display module is electrically connected with said PCB by a wire.

9. The LCD device of claim 3, wherein said LCD device further comprises a display module and a PCB; said display module is arranged inside the backplane, said PCB is arranged outside the backplane, and said display module is electrically connected with said PCB by a wire.

10. The LCD device of claim 4, wherein said LCD device further comprises a display module and a PCB; said display module is arranged inside the backplane, said PCB is arranged outside the backplane, and said display module is electrically connected with said PCB by a wire.

11. The LCD device of claim 7, wherein said LCD device further comprises a base and a bracket; said PCB is arranged on said bracket.

12. The LCD device of claim 11, wherein said PCB is arranged in a protective case.

13. The LCD device of claim 12, wherein said protective case is arranged on the rear of said bracket.
